(19) United States
(12) Patent Application Publication
(10) Pub. No.: US 2005/0262296 A1
(43) Pub. Date: Nov. 24, 2005

(54) Selective dual copy control of data storage and copying in a peer-to-peer virtual tape server system

(75) Inventor: Jonathan W. Peake, Tucson, AZ (US)

Correspondence Address: SWANSON & BRATSCHUN, LLC - IBM, 1745 SHEA CENTER DRIVE, SUITE 330, HIGHLANDS RANCH, CO, 80129, US

(73) Assignee: International Business Machines (IBM) Corporation, Armonk, NY (US)

(21) Appl. No.: 10/850,194

(22) Filed: May 20, 2004

(51) Int. Cl. G06F 12/00

(52) U.S. Cl. 711/111; 711/165

(57) ABSTRACT

A method of storing data to one of a first or second storage device associated with a data storage system where each storage device provides for the redundant access to and storage of data within the same logical data volumes. The method of storing data consists of defining a storage construct which will direct the performance of a specific storage function. The storage construct is then associated with a logical data volume. The method further consists of mounting the logical data volume residing on one of the two storage devices and executing a storage function in accordance with the storage construct. The storage construct may be defined by a command issued by a host associated with the data storage system. Alternatively, the storage construct may be defined by a user of the data storage system through a user interface. The storage function which is directed by the defined storage construct may consist of selecting which one of the first and second storage devices will execute input/output (I/O) commands received from the data storage system for a particular logical data volume mount. Alternatively, the storage function may consist of determining whether data stored to a logical data volume physically associated with one of the storage devices will be copied to the other storage device. Other storage functions can be directed by a storage construct.

### TECHNICAL FIELD

The present invention relates to a method, data storage system, and article of manufacture for storing data in a data processing system, in particular controlling whether to copy data from one virtual tape server to another virtual tape server in a peer-to-peer environment, and selecting which peer will initially store data.

### BACKGROUND ART

In prior art virtual tape storage systems, hard disk drive storage is used to emulate tape drives and tape cartridges. In this way, host systems performing input/output (I/O) operations with respect to tape are in fact performing I/O operations with respect to a set of hard disk drives emulating the tape storage. In the prior art International Business Machines (IBM) Magstar Virtual Tape Server®, one or more virtual tape servers (“VTS”) are each integrated with a tape library comprising numerous tape cartridges and tape drives, and have a direct access storage device (DASD) comprised of numerous interconnected hard disk drives. The operation of the virtual tape server is transparent to the host. The host makes a request to access a tape volume. The virtual tape server intercepts the tape requests and accesses the volume in the DASD. If the volume is not in the DASD, then the virtual tape server recalls the volume from the tape drive to the DASD. The virtual tape server can respond to host requests for volumes in tape cartridges from DASD substantially faster than responding to requests for data from a tape drive. Thus, the DASD functions as a tape volume cache for volumes in the tape cartridge library.

Two virtual tape servers can be combined to create a peer-to-peer virtual tape server. In a peer-to-peer virtual tape server, two virtual tape servers, each integrated with a separate tape library, can provide access and storage for the same data volumes (i.e. peer-to-peer environment). By providing two virtual tape server subsystems and two libraries, if an operation to access a logical volume from one virtual tape server subsystem and tape library fails, then the volume may still be accessed from the other virtual tape server subsystem and tape library. This redundant architecture provides greater data and tape availability and improved data shadowing in the event a tape or virtual tape server in one subsystem is damaged. Therefore, when a host system writes to the peer-to-peer virtual tape server, the data will be saved on both virtual tape servers. However, rather than writing to both virtual tape servers simultaneously, which would be a drain on system resources, a virtual tape controller connecting the two virtual tape servers will first write the logical volume to one of the virtual tape servers. An example of a virtual tape controller is the IBM AX0 Virtual Tape Controller (“AX0 VTC”) which acts as an intelligent switch between the two virtual tape servers and transparently connects the host computers with the virtual tape servers. Then, the logical volume is copied by the virtual tape controller from one virtual tape server to the other virtual tape server when the host closes the volume. The copying process between the virtual tape servers can occur immediately upon close of the volume or be deferred based on user preferences. There can also be a case where some elements of the peer-to-peer virtual tape server are unavailable for a period of time and it is necessary to ‘catch’ up on volumes that have not been copied. The automatic copying of volumes between the virtual tape servers that make up a peer-to-peer virtual tape server system is a key part of its data availability characteristics.

While the automatic copying of a logical volume is a key part of the peer-to-peer virtual tape system, not all logical volume data created by a host have the same level of importance. For some logical volumes, the ability to access it at any time is critical, but for other volumes, it is acceptable to have the volume be temporarily unavailable. For example, a volume that is created as the result of testing a new or modified host application is not critical to the daily operation of the customer's business and typically has no value after the test is performed. In addition, there are costs associated with the copying of a logical volume in a peer-to-peer virtual tape server. The logical volume takes up space in the disk cache of each of the VTSs as well as space on the physical tapes in the library associated with each VTS. In many peer-to-peer virtual tape server configurations, virtual tape controllers and virtual tape servers are geographically separated and there are costs associated with the transmission of the data between these elements. Thus, there is a need in the art for a method to selectively control the logical volumes that are copied in a peer-to-peer virtual tape server system.

In the case where the physical elements of the peer-to-peer virtual tape server are geographically separated, it is also desirable to direct the host data creating a logical volume to a specific virtual tape server. The virtual tape server the data is to be directed to may be one virtual tape server for some data and another virtual tape server for other data. For example, a logical volume created by the application development group in a company may need to only go to the virtual tape server that resides at the site that houses that group, typically the customer's main site. If a virtual tape server remotely located from the customer's main site is selected, expensive remote connection bandwidth will be used, increasing the cost of the development of a new application. In another example, data that is critical to the continued operations of the company may need to be directed to the remote site first, thus allowing the company's operations to continue should there be a disaster involving the main site, whether or not the data is copied later to the other virtual tape server at the main site. Thus, there is a need in the art for a method to selectively direct the initial host data to one or the other virtual tape server in a peer-to-peer virtual tape server system where, for example, the data of a logical volume is not to be copied from one virtual tape server to the other or if it is important that the data first be written to a specific virtual tape server before being copied.

### SUMMARY OF THE INVENTION

The needs in the art are addressed by a method of storing data to one of a first or second storage device associated with a data storage system where each storage device provides for the redundant access to and storage of data within the same logical data volumes. For example, the data storage devices may be virtual tape servers in a peer-to-peer data storage relationship. The method of storing data consists of defining a storage construct which will direct the performance of a specific storage function. The storage construct is then associated with a logical data volume. The method further consists of mounting the logical data volume residing on one of the two storage devices and executing a storage function in accordance with the storage construct.

The storage construct may be defined by a command issued by a host associated with the data storage system. Alternatively, the storage construct may be defined by a user of the data storage system through a user interface.

The storage function which is directed by the defined storage construct may consist of selecting which one of the first and second storage devices will execute input/output (I/O) commands received from the data storage system for a particular logical data volume mount. Alternatively, the storage function may consist of determining whether data stored to a logical data volume physically associated with one of the storage devices will be copied, pursuant to peer-to-peer (PTP) or other protocols, to the logical data volume physically associated with the other storage device. Other storage functions can be directed by a storage construct.

In one embodiment of the invention where the first storage device and the second storage device are first and second virtual tape servers, the mounting of a logical data volume may consist of sending a mount command from a host to a virtual tape controller. The virtual tape controller may then pass the mount to the first and second virtual tape servers. The mount command will be processed by the first and second virtual tape servers with the processing including the association of the storage construct with the logical storage volume being mounted. The storage construct associated with the logical data volume may also be passed back to the virtual tape controller and retained. A mount operation may be completed by notifying the host.

Another embodiment of the invention is a data storage system capable of performing the above described steps for storing data.

A further embodiment of the invention is an article of manufacture comprising a storage medium having logic embedded therein for programming the components of a data storage system to execute the steps described above for storing data.

### BRIEF DESCRIPTION OF THE DRAWINGS

FIG. 1 is a block diagram illustrating a computing environment in which a preferred embodiment may be implemented;

FIG. 2 illustrates a token database record used to access data in accordance with an embodiment of the present invention;

FIG. 3 illustrates a construct management database and data structures used to associate logical volumes to management actions in accordance with an embodiment of the present invention;

FIG. 4 is a data flow diagram that illustrates one manner in which one or more constructs for a logical volume are assigned through a control console of a library manager in accordance with an embodiment of the present invention;

FIG. 5 illustrates logic in the virtual tape controller, virtual tape servers and library managers to receive a mount request and constructs then determine from the management actions associated with the constructs assigned to the logical volume which VTS is to perform the host I/O operations in accordance with an embodiment of the present invention;

FIG. 6 illustrates logic in the virtual tape controller, virtual tape servers and library managers to receive a mount request and based on user assigned constructs, determine from the management actions associated with the constructs assigned to the logical volume which VTS is to perform the host I/O operations in accordance with an embodiment of the present invention;

FIG. 7 illustrates logic in the virtual tape controller for the processing of host I/O operations to determine whether a logical volume is to be inhibited or not in accordance with an embodiment of the present invention; and

FIG. 8 illustrates logic in the virtual tape controller to establish a list of logical volumes that are to be copied taking into account whether copying for a logical volume is to be inhibited or not in accordance with an embodiment of the present invention.

### DETAILED DESCRIPTION OF THE PREFERRED EMBODIMENT

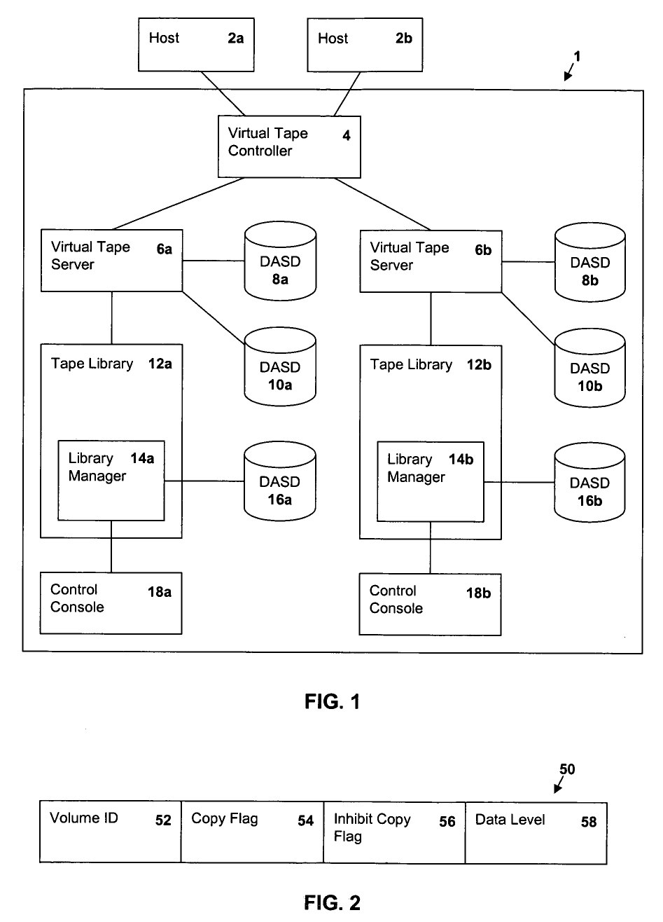

FIG. 1 illustrates a peer-to-peer (PTP) computing system 1 environment utilizing two virtual tape servers (“VTS”). Although FIG. 1 shows VTS devices, the invention disclosed herein is applicable to any type of data storage system using two or more storage devices of any nature where each storage device provides for redundant access to an storage of data within the same logical volumes. Additional virtual tape servers can be used by a system, but for purposes of illustration, a single pair arrangement is shown. A plurality of host computers 2a, 2b (two host computers 2a, 2b are shown for illustration purposes) connect to the system 1 through a virtual tape controller 4 (“VTC”). The hosts 2a, 2b may be any computational device known in the art, such as a personal computer, a workstation, a server, a mainframe, a hand held computer, a palm top computer, a telephony device, network appliance, etc. The hosts may include an operating system such as the IBM z/OS operating system, or any other operating system known in the art. Additional virtual tape controllers can be used by the system, but for the purposes of illustration, a single virtual tape controller is shown. The host computers 2a, 2b may connect to the VTC 4 through a channel, such as an Enterprise System Connection (ESCON) channel or other interface mechanism known in the art (e.g., fibre channel, Storage Area Network (SAN) interconnections, etc.). In a peer-to-peer environment, the virtual tape controller 4 is typically transparent to the host computers 2a, 2b (i.e. the host system acts as if the host computers 2a, 2b are writing to a single virtual tape server). The virtual tape controller 4 then routes I/O requests from the hosts 2a, 2b to one of the virtual tape servers 6a or 6b. The virtual tape servers 6a, 6b control access to direct access storage devices (DASD) 8a and 8b and tape libraries 12a and 12b, respectively.

Each DASD 8a, 8b comprises numerous interconnected hard disk drives. Each tape library 12a, 12b comprises numerous tape cartridges which may be mechanically loaded into tape drives that the virtual tape servers 6a, 6b may access. The virtual tape servers 6a or 6b may comprise a server system including software to emulate a tape library, such as the IBM TotalStorage Virtual Tape Server. For instance, the virtual tape servers 6a, 6b and the virtual tape controller 4 may be implemented in separate computers comprising an IBM pSeries processor, the IBM AIX operating system, and the IBM ADSTAR Distributed Management (ADSM) software or Tivoli Storage Manager, to perform the data movement operations among the hosts 2a, 2b, DASDs 8a, 8b, and tape libraries 12a, 12b. The tape library may comprise an IBM Magstar Tape Library, such as the Magstar 3494 Tape Library, or any other tape library system known in the art.

The DASDs 8a, 8b provide a tape volume cache, which extends the performance benefits of disk cache to access the volumes in the tape libraries 12a, 12b and improves performance by allowing host I/O requests to the tape libraries 12a, 12b to be serviced from the DASDs 8a, b. The virtual tape servers 6a, 6b appear to the hosts 2a, 2b as tape drives including tape data volumes. The hosts 2a, 2b view the logical tape volumes as actual tape volumes and issue tape management commands, such as mount, and otherwise address the virtual tape servers 6a, 6b as a tape control unit. Further details of the virtual tape server technology in which embodiments may be implemented are described in the IBM publications “IBM TotalStorage Virtual Tape Server: Planning, Implementing, and Monitoring” IBM document no. SG24-2229-06 (Copyright IBM, November 2003) and “IBM TotalStorage Peer-to-Peer Virtual Tape Server: Planning and Implementation Guide” IBM document no. SG24-6115-02 (Copyright IBM, February 2004), which publications are incorporated herein by reference in their entirety.

Tape data volumes maintained on tape cartridges in the tape library 12a, 12b are logical volumes. A copy of a logical volume can also reside in the DASDs 8a, 8b associated with the virtual tape servers 6a, 6b. A host 2a, 2b accesses the data on a logical volume from the resident copy on the DASD 8a, 8b. After the DASDs 8a, 8b space usage reaches a threshold amount, the virtual tape server 6a, 6b removes logical volumes that have been copied to a tape library 12a, 12b from the DASD 8a, 8b to make room for other logical volumes. Once a logical volume has been removed from the DASDs 8a, 8b, it is no longer accessible by a host. If a host 2a, 2b requests a volume that only resides on a physical tape, then the volume must be recalled and copied from a physical tape in the tape libraries 12a, 12b to the DASDs 8a, 8b. Recall operations can take several minutes and may include mechanical operations concerning the use of a robotic arm to access tape cartridges from the storage cells in tape libraries 12a, 12b, insert it into a tape drive, mount the tape cartridge, rewind the tape, etc. The tape libraries 12a, 12b may not include the same logical volumes since each virtual tape server 6a, 6b typically behaves independently, and each may cache different volumes in DASD. For example, the virtual tape servers 6a, 6b may have different volumes resident in their associated DASDs 8a, 8b as a result of different schedules or algorithms that determine which volumes to remove or which VTS is the target for host data or whether the data is to be copied or not.

As long as a logical volume is still resident in the DASDs 8a, 8b, it can be accessed again by a host regardless of whether it has been copied to the tape library 12a, 12b or not. By allowing a volume to be mounted and accessed from DASDs 8a, 8b, delay times associated with rewinding the tape, robotic arm movement, and load time for the mounts are avoided because the operations are performed with respect to hard disk drives that do not have the delay times associated with tape access mechanisms. Performing a virtual mount of a logical volume resident in DASD 8a, 8b is often referred to as a cache hit.

Each virtual tape server 6a, 6b may include a database on DASD 10a, 10b of tokens or records for every logical volume in the tape library 12a, 12b to manage the volumes in the virtual tape servers 6a, 6b. Each tape library 12a, 12b may contain a library manager 14a, 14b which manages the physical tape drives and media and the robotics that moves the media between storage cells and the physical tape drives. The library manager 14a, 14b also may manage a construct management database on DASD 16a, 16b that contains the storage management constructs and management actions associated with each logical volume as disclosed herein. A control console 18a, 18b is typically attached to each library manager. The library manager 12a, 12b and control console 18a, 18b may be any computational device known in the art, such as a personal computer, a workstation, a server, a mainframe, a hand held computer, a palm top computer, a telephony device, network appliance, etc.

FIG. 2 illustrates representative fields or data maintained in each volume token 50 which is stored in a DASD token database 10a, 10b. The volume ID 52 indicates the identity of the volume. It is common to refer to the identity of a volume by its volume serial number, which is typically 1 to 6 characters in length. A copy flag 54 indicates whether the data needs to be copied to the other virtual tape server in a peer-to-peer environment or other data copying environment. For example, the copy flag 54 is set “on” for a logical volume in one virtual tape server 6a if the data needs to be copied to the other virtual tape server 6b. If the data is copied, it is placed in the DASD 8b just as if the host had originally written it there. After a logical volume has been copied from virtual tape server 6a, the copy flag 54 is set “off” again in virtual tape server 6a's token database 10a. A copy inhibit flag 56 as is fully described below may be used to indicate whether the copying of data for the volume is to be inhibited. The copy inhibit flag 56 is set to “on” for a logical volume if the volume is not to be copied to another virtual tape server, even if the copy flag 54 is set to “on”. Whereas the copy flag 54 is typically only set to “on” in one of the virtual tape servers 6a, b and token databases 10a, 10b, the copy inhibit flag 56 can be set to “on” in both virtual tape servers 6a, 6b token databases 10a, b. As described below, the copy inhibit flag 56 may be set to “off” again if the volume is again allowed to be copied to another virtual tape server 6a, 6b. Data level 58 indicates the number of times the file has been updated. Every time data is updated to a logical volume, the level field 58 is incremented indicating the number of times a volume in a particular DASD 8a, 8b has been updated. The logical volume in the DASDs 8a, 8b having the highest data level contains the most recent version of the logical volume. For this reason, the virtual tape server 6a, 6b including the most recent version of the data, i.e., having the highest level, will typically be selected when performing I/O operations with respect to the volume. It will be apparent to one skilled in the art that the flags and data level fields of the volume token 50 could be represented by binary, numeric or character values, or a combination thereof.

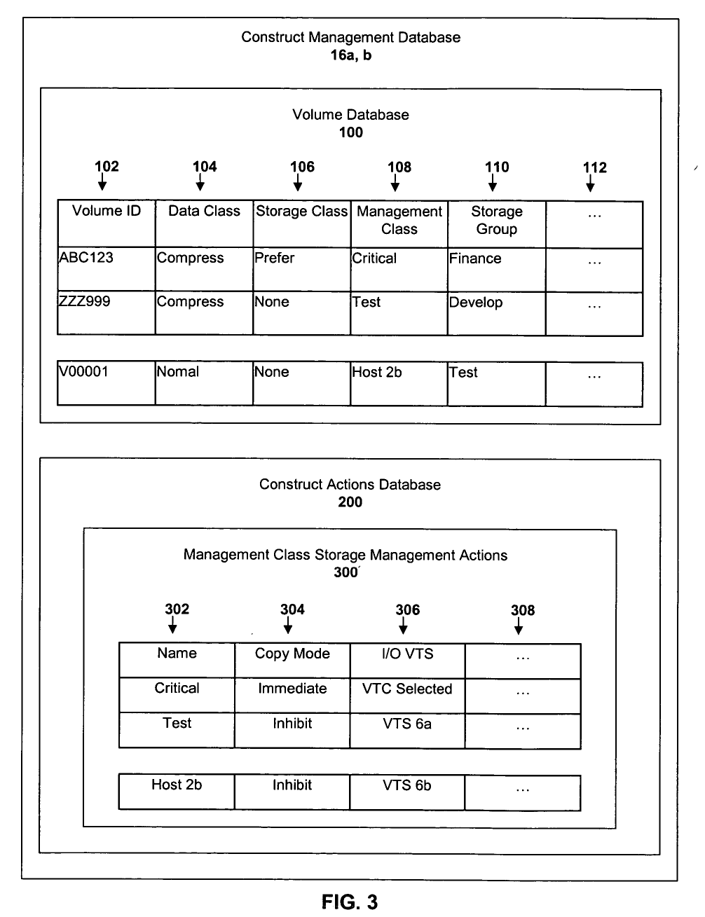

Referring to FIG. 3, the contents of a construct management database 16a, 16b of a library manager 14a, 14b are depicted. In one embodiment of the invention, the construct management database 16a, 16b contains a volume database 100 that a library manager 14a, 14b uses to store information associated with each of the logical volumes it manages. The volume database 100 contains a plurality of volume IDs 102, which are typically the volume serial number of the logical volume. Additionally, the volume database 100 contains a plurality of constructs 104, 106, 108, 110 pertaining to each volume ID 102. The constructs 104, 106, 108, 110 in the depicted embodiment include a data class 104, a storage class 106, a management class 108 and a storage group 110. Furthermore, the volume database 100 may contain additional information 112 about each of the volume IDs 102, not shown in FIG. 3. Although values are shown in FIG. 3 for data class 104, storage class 106 and storage group 110, for the embodiment of the invention, management class 108, is used to control storage functions such as discussed in detail herein whether the copying of a logical volume is to be inhibited or not or which virtual tape server 6a or 6b will handle host I/O operations. Although not described in detail herein, one of the other listed storage constructs, or an unlisted storage construct, could be used in the management of logical volumes in a peer-to-peer virtual tape server system in accordance with the invention.

In one preferred embodiment of the invention, the management class 108 relates to the importance of the data stored on a logical volume and the ability of the system 1 to allow access to the logical volume in the event of a failure of an element of the data storage system 1. For example, volume ID 102 “ABC123” which contains data that absolutely must be accessible may have a management class 108 of “Critical”, while a management class 108 of “Test” may be assigned to volume ID 102 “ZZZ999” which contains data for which access can be lost for a period of time. It will be understood by those skilled in the art that the example management class 108 constructs depicted in FIG. 3 are a small subset of the possible names that could be used.

The construct management database 16a, 16b of the library manager 14a, 14b may also contain a construct actions database 200 that the library manager 14a, 14b uses to store information about the storage management actions associated with each of the storage management constructs to be used. For clarity, only certain management class storage management actions 300 which are particularly associated with the embodiment of the present invention described in detail are shown. The management class storage management actions 300 contains a plurality of names 302, which are the management class 108 construct names defined for use by the system 1. Additionally, the management class storage management actions 300 may contain a plurality of copy mode 304 and I/O VTS 306 actions pertaining to each name 302. For example, a name 302 of “Critical” may have a copy mode 304 of “Immediate” meaning that when the host has finished writing the logical volume and is in the process of closing the logical volume, the copying of the logical volume is completed prior to informing the host that the logical volume has been closed. The name 302 of “Critical” may also have an I/O VTS 306 of “VTC Selected” meaning that the choice of which virtual tape server 6a, 6b is to handle all host I/O operations for the logical volume is to be determined by the virtual tape controller 4 based upon an analysis of system resources, system stability and other factors. Similarly, a name 302 of “Test” may have a copy mode 304 of “Inhibit” meaning that regardless of whether the logical volume should be copied, copying of the logical volume is inhibited. The name 302 of “Test” may also have an I/O VTS 306 of “VTS 6a” meaning that the virtual tape server 4 is to use virtual tape server 6a to handle all host I/O operations for the logical volume. Furthermore, the management class storage management actions 300 may contain additional actions 308 which are not shown on FIG. 3 about each of the management class 108 names which are useful for purposes other than the control of the inhibiting of copying a logical volume or controlling which virtual tape server 6a, 6b will handle host I/O operations.

In one embodiment, the storage management actions 300 are defined by a user through a user interface, for example through a library manager 14a, 14b control console 18a, 18b. In another embodiment, the storage management actions are defined through commands issued by one of the hosts 2a, 2b.

In addition to the above embodiment of the contents of the construct management database 16a, 16b, it will be readily understood to those familiar with the art that the contents of the volume database 100 and the construct actions database 200 may be combined into a single database.

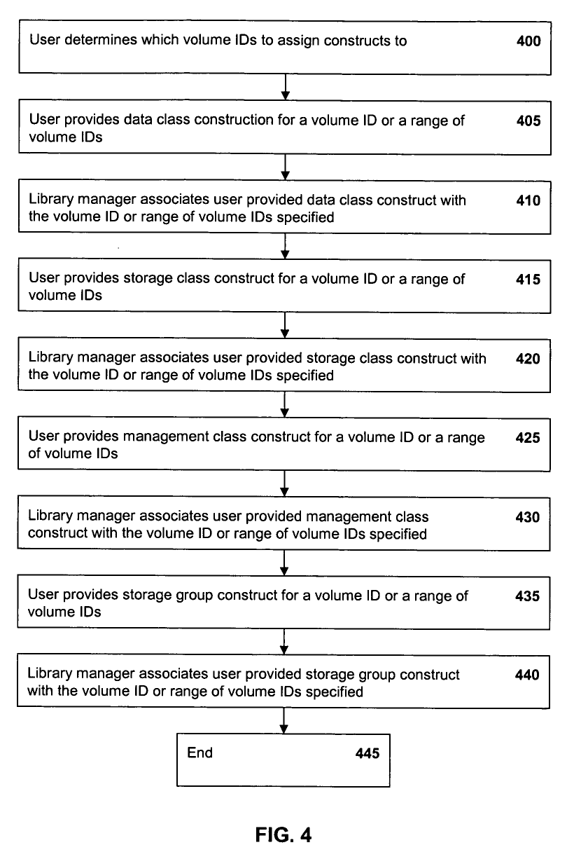

In one embodiment, the constructs 104, 106, 108, 110 that are to be associated with a logical volume are provided by a host 2a, 2b as part of the volume mount process. In another embodiment, the assignment of constructs 104, 106, 108, 110 is performed independent of a host mount request by a user through a user interface such as a library manager 14a, 14b control console 18a, 18b. FIG. 4 is a data flow diagram that illustrates one manner in which one or more constructs for a logical volume are assigned using a library manager 14a, 14b control console 18a, 18b. Beginning with step 400, the user determines which volume IDs 102 are to be assigned constructs 104 or 106 or 108 or 110. For example, the user may decide that all of the logical volumes used by specific host 2b are to be inhibited from being copied and so decides that they all would have a management class 108 construct name of “Host 2b”. Based on other criteria, the user may select constructs names for data class 104, storage class 106 and storage group 110. The user is preferably not restricted to a limited selection of construct 104, 106, 108, 110 names, nor restricted in which volumes IDs 102 are assigned which constructs 104, 106, 108, 110 or if all constructs must be defined for each volume ID 102. In step 405, the user enters the data class 104 construct name and either a specific volume ID 102 or a range of volume IDs 102 that are to be assigned data class 104 through the control console 18a, 18b. In step 410, the library manager 14a, 14b, stores the user provided data class 104 name in the volume database 100 for the user provided volume ID 102 or range of user provided volume IDs 102. If the user did not provide a data class 104 in step 405, step 410 is skipped. In step 415, the user enters the storage class 106 construct name and either a specific volume ID 102 or a range of volume IDs 102 that are to be assigned storage class 106 through the control console 18a, 18b. In step 420, the library manager 14a, 14b, stores the user provided storage class 106 name in the volume database 100 for the user provided volume ID 102 or range of user provided volume IDs 102. If the user did not provide a storage class 106 in step 415, step 420 is skipped. In step 425, the user enters the management class 108 construct name and either a specific volume ID 102 or a range of volume IDs 102 that are to be assigned management class 108 through the control console 18a, 18b. In step 430, the library manager 14a, 14b, stores the user provided management class 104 name in the volume database 100 for the user provided volume ID 102 or range of user provided volume IDs 102. If the user did not provide a management class 108 in step 425, step 430 is skipped. In step 435, the user enters the storage group 110 construct name and either a specific volume ID 102 or a range of volume IDs 102 that are to be assigned storage group 110 through the control console 18a, 18b. In step 410, the library manager 14a, 14b, stores the user provided storage group 110 name in the volume database 100 for the user provided volume ID 102 or range of user provided volume IDs 102. If the user did not provide a storage group 110 in step 435, step 440 is skipped. The flow terminates at step 445.

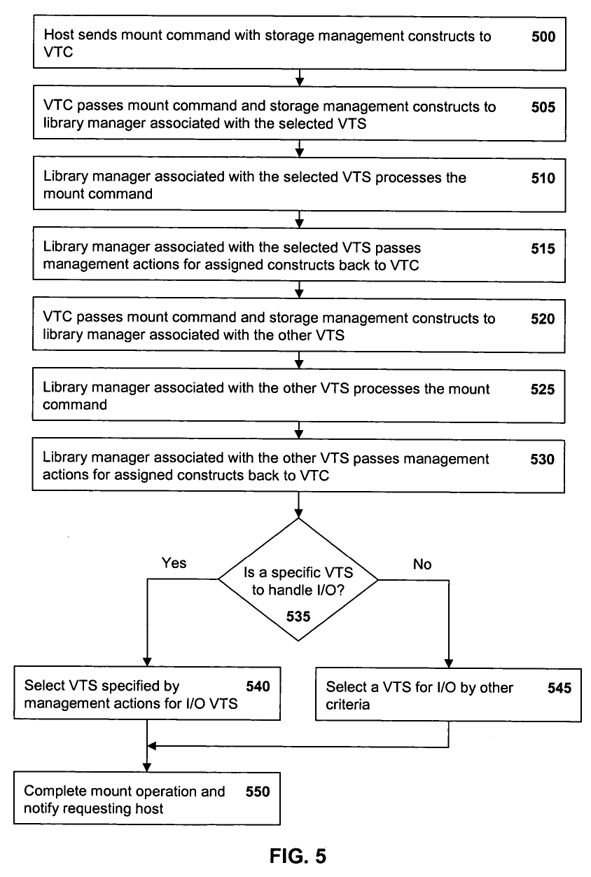

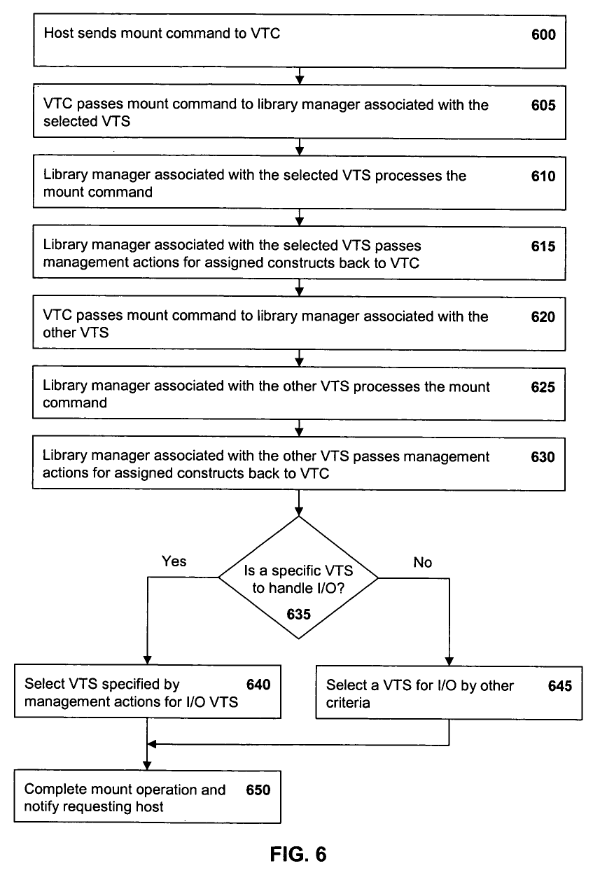

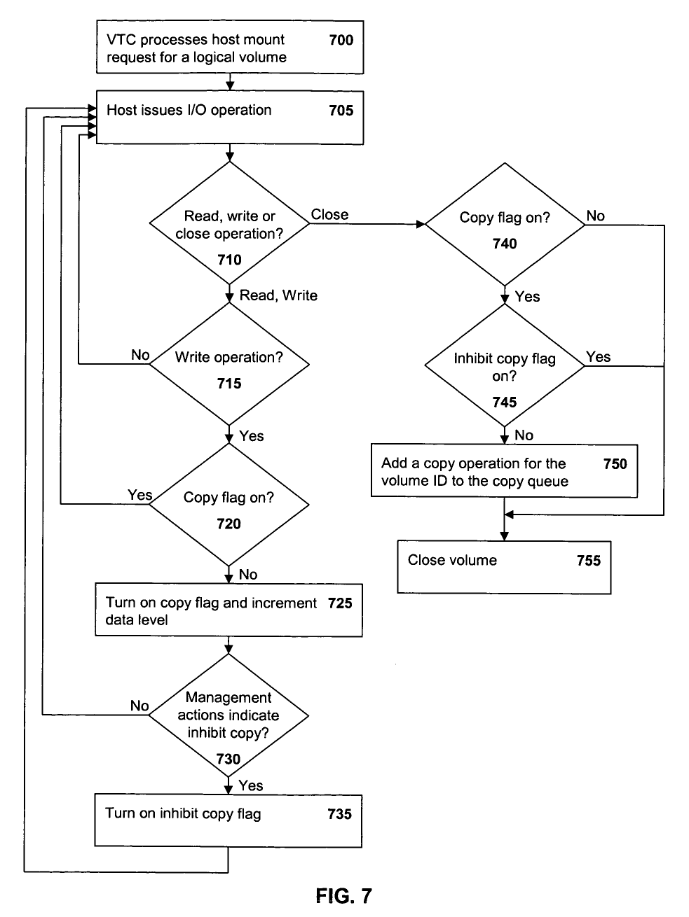

The determinations regarding the performance of storage functions such as whether to inhibit the copying of a logical volume and which virtual tape server 6a, 6b is to handle the host I/O operations for a logical volume are preferably made by the virtual tape controller 4 using the management actions 300 established via a library manager 14a, 14b control console 18a, 18b. Hence, the determination of whether the copying of a logical volume is to be inhibited or not or which virtual tape server 6a, 6b will process host I/O for a volume is made in a manner that is transparent to the hosts 2a, 2b. In the one embodiment, a host 2a, 2b provides the constructs 104, 106, 108, 110 associated with each logical volume, but the storage management actions 300 need not be dealt with by the host 2a, 2b. In another embodiment, the constructs 104, 106, 108, 110 associated with each logical volume are assigned by a user through a library manager 14a, 14b control console 18a, 18b. The manner in which a virtual tape server is selected to process host I/O using the storage management actions 300 will be further described in connection with FIG. 5 and in an alternative embodiment of the invention in connection with FIG. 6. The manner in which volume copying is inhibited or not using the storage management actions will be further described in a preferred embodiment of the invention in connection with FIG. 7.

Referring to FIG. 5, a data flow diagram illustrates one manner in which the constructs for a logical volume are provided by the host 2a, 2b and retained in the construct management database 100 on DASD 16a, 16b. In step 500, the host 2a, 2b transmits a mount command to the virtual tape controller 4. The mount command indicates that the request is for a new logical volume and includes the constructs data class 104, storage class 106, management class 108 and storage group 110 to be associated with the logical volume selected for the mount request. As mentioned previously, the constructs 104, 106, 108, 110 in one embodiment do not specify which virtual tape server is to handle the I/O operations for the mount or whether copying of the logical volume is to be inhibited or not. In step 505, the virtual tape controller 4 passes the mount command and included constructs through one virtual tape server 6a or 6b to its associated library manager 14a or 14b. In step 510, the library manager 14a or 14b associated with the selected virtual tape server 6a or 6b processes the mount command, processing which includes indicating in the volume database 100 that the volume is in use, selecting a logical volume from a list of logical volumes available for new data, and updating the volume database 100 record for the selected volume ID 102 with the constructs 104, 106, 108 and 110. In step 515, the library manager 14a or 14b associated with the selected virtual tape server 6a or 6b obtains the storage management actions for each of the constructs 104, 106, 108 and 110 for the selected volume ID 102 and passes them back to virtual tape controller 4 which retains them. In step 520, the virtual tape controller 4 passes the mount command, the selected volume ID 102 and the constructs 104, 106, 108, 110 through the other virtual tape server 6a or 6b to its associated library manager 14a or 14b. In step 525, the library manager 14a or 14b associated with the other virtual tape server 6a or 6b processes the mount command, processing which includes indicating in the volume database 100 that the volume is in use and updates the volume database 100 record for the volume ID 102 passed from the virtual tape controller 4 with the constructs 104, 106, 108 and 110. In step 530, the library manager 14a or 14b associated with the other virtual tape server 6a or 6b obtains the storage management actions for each of the constructs 104, 106, 108 and 110 for the volume ID 102 and passes them back to virtual tape controller 4 which retains them. Referring now to step 535, the virtual tape controller 4, using the retained storage management actions passed from the library manager 14a or 14b associated with the selected virtual tape server 6a or 6b, and specifically using the storage management action I/O VTS 306 for the associated management class 108, determines whether a specific virtual tape server is to be used for the duration of the mount. If the I/O VTS 306 action specified one of the virtual tape server IDs, for example “VTS 6a”, then the flow proceeds to step 540. If the I/O VTS 306 action specified “VTC Selected”, then the flow proceeds to step 545. As shown in step 540, virtual tape server 6a is selected to handle all of the I/O operations for the mount, based on the specified I/O VTS 306 action of “VTS 6a” and the flow proceeds to step 550. Alternatively, as shown in step 545, the virtual tape controller 4 determines which virtual tape server 6a, 6b is to be selected to handle all of the I/O operations for the mount, based on system resource and other criteria established for the selection and purpose the flow also proceeds to step 550. In step 550, the virtual tape controller 4 completes the mount operation by notifying the host 2a, 2b that issued the mount command that the mount request has been successfully satisfied and that I/O operations to the selected logical volume can proceed.

FIG. 6 illustrates an alternative data flow of an alternative embodiment in which the constructs for a logical volume were provided by a user through a user interface such as the library manager 14a, 14b control console 18a, 18b and retained in the construct management database 100 on DASD 16a, 16b. In step 600, the host 2a, 2b transmits a mount command to the virtual tape controller 4. The mount command indicates a specific logical volume is to be used for the mount request. In contrast with the embodiment described in FIG. 5, the host 2a, 2b does not provide constructs to associate with the logical volume. In step 605, the virtual tape controller 4 passes the mount command through a selected virtual tape server 6a or 6b to its associated library manager 14a or 14b. In step 610, the library manager 14a or 14b associated with the selected virtual tape server 6a or 6b processes the mount command, processing which includes indicating in the volume database 100 that the specified volume, identified by volume ID 102, is in use. In step 615, the library manager 14a or 14b associated with the selected virtual tape server 6a or 6b obtains the storage management actions for each of the constructs 104, 106, 108 and 110 previously assigned to the specified volume ID 102 and passes them back to virtual tape controller 4 which retains them. In step 620, the virtual tape controller 4 passes the mount command through to the other virtual tape server 6a or 6b, and thus to its associated library manager 14a or 14b. In step 625, the library manager 14a or 14b associated with the other virtual tape server 6a or 6b processes the mount command, processing which includes indicating in the volume database 100 that the specified volume, identified by volume ID 102, is in use. In step 630, the library manager 14a or 14b associated with the other virtual tape server 6a or 6b obtains the storage management actions for each of the constructs 104, 106, 108 and 110 for the volume ID 102 and passes them back to virtual tape controller 4 which retains them. Referring now to step 635, the virtual tape controller 4, using the retained storage management actions passed from the library manager 14a or 14b associated with the selected virtual tape server 6a or 6b, specifically using the storage management action I/O VTS 306 for the associated management class 108, determines whether a specific virtual tape server is to be used or if the virtual tape controller 4 is to select the virtual tape server for all I/O operations for the duration of the mount. If the I/O VTS 306 action specified one of the virtual tape server IDs, for example “VTS 6a”, then the flow proceeds to step 640. If the I/O VTS 306 action specified “VTC Selected”, then the flow proceeds to step 645. Referring back to step 640, virtual tape server 6a is shown as having been selected to handle all of the I/O operations for the mount, based on the specified I/O VTS 306 action of “VTS 6a” and the flow proceeds to step 650. Alternatively, referring to step 645, if the virtual tape controller 4 is to determine which virtual tape server 6a, 6b is to be selected to handle all of the I/O operations for the mount, based on system resource and other criteria the selection is made and the flow also proceeds to step 650. In step 650, the virtual tape controller 4 completes the mount operation by notifying the host 2a, 2b that issued the mount command that the mount request has been successfully satisfied and that I/O operations to the selected logical volume can proceed.

FIG. 7 is a flow diagram which illustrates one manner in which the virtual tape controller 4 can process host I/O operations. Control begins at step 700, when a host computer 2a or 2b requests a mount of a logical volume and the steps previously described in the embodiment of FIG. 5 or the alternative embodiment of FIG. 6 are performed including notifying the requesting host that the mount has been completed. The host issues an I/O operation to the virtual tape controller 4 at step 705. At step 710, the virtual tape controller 4 determines whether the I/O operation is a read, write or volume close type operation. If it is a read or write operation, the virtual tape controller 4, at step 715, further determines whether the operation is a write operation. If the operation is a read operation, the read occurs and the flow proceeds back to step 705 with the virtual tape controller 4 waiting for the next host I/O operation. If the operation is a write operation, the virtual tape controller 4, at step 720 determines whether the copy flag 54 is “on” in the volume's token 50. If the copy flag 54 is “on” then the write occurs and the flow proceeds back to step 705 with the virtual tape controller 4 waiting for the next host I/O operation. If the copy flag 54 is not “on”, then at step 725 the virtual tape controller 4 turns the flag “on” and also increments the data level 58. By verifying that a copy flag is turned on after every write operation, the virtual tape controller 4 ensures that a newly written or modified volume is marked for copying. Next, at step 730, using the retained storage management actions passed from the library manager 14a or 14b associated with the selected virtual tape server 6a or 6b, and specifically using the storage management action copy mode 304 for the associated management class 108, the virtual tape controller 4 determines if copy mode 304 is set to “inhibit”. If the copy mode 304 is set to something other than “inhibit” then the flow proceeds back to step 705 and the virtual tape controller 4 waits for the next host I/O operation. If the copy mode 304 is set to “inhibit” then at step 735 the virtual tape controller 4 turns the inhibit copy flag 56 “on” in the volume's token 50 and then the flow proceeds back to step 705 and the virtual tape controller 4 waits for the next host I/O operation. If, at step 710, the I/O operation was a volume close, the virtual tape controller 4, at step 740, determines if the copy flag 54 is “on” in the volume's token 50. If the copy flag 54 is “on”, then at step 745 the virtual tape controller 4 determines if the inhibit copy flag 56 is “on” in the volume's token 50. If the inhibit copy flag 56 is not “on”, at step 750 the virtual tape controller 4 places a copy operation for the logical volume identified by the volume ID 50 in the queue for pending copy operations, and the flow continues to step 755. If, at step 740, the virtual tape controller 4 determined that the copy flag 54 was not set to “on” the flow proceeds to step 755. If, at step 745, the virtual tape controller 4 determined that the inhibit copy flag 56 was set to “on” the flow proceeds to step 755. In such a case, at step 755, the virtual tape controller 4 performs a close operation for the volume without placing a copy operation in the queue for pending copy operations.

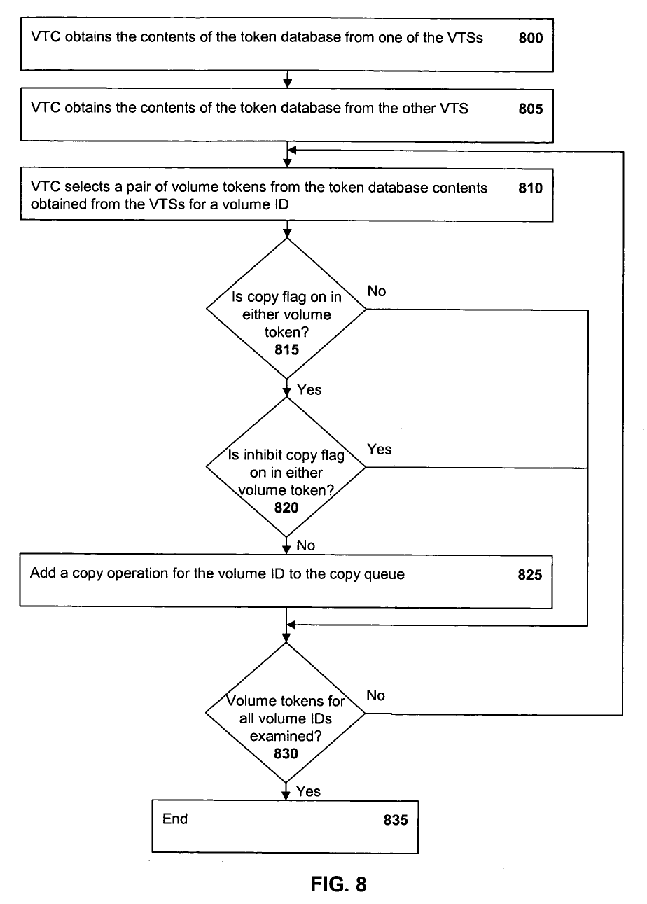

In addition to determining whether a newly created or modified logical volume is to be copied in the steps detailed in FIG. 7, FIG. 8 illustrates the logic implemented in the virtual tape controller 4 to establish a list of logical volume that are to be copied when a) the peer-to-peer virtual tape server system 1 is powered on, b) when one of the virtual tape servers 6a or 6b is available to the system after being unavailable due to a failure, maintenance or upgrade, or c) as a periodic background task. As part of determining whether a logical volume is to be copied or not, the state of the copy flag 54 and inhibit copy flag 56 are examined. Beginning with step 800, the virtual tape controller 4 obtains the contents of the token database 10a from virtual tape server 6a. In step 805, the virtual tape controller 4 obtains the contents of the token database 10b from virtual tape server 6b. The above described order in which the contents of the token databases are obtained from their associated virtual tape server is not important. In step 810, the virtual tape controller 4 selects a volume token 50 from the contents obtained from each of the token databases 10a and 10b for a volume ID 52. In step 815, the virtual tape controller 4 determines if the copy flag 54 in either volume token 50 is “on”. If “on” the flow proceeds to step 820. If the copy flag 54 is not “on” in either volume token, the flow proceeds to step 830. Now referring to step 820, the virtual tape controller 4 examines the inhibit copy flag 56 to see if it is set to “on” in either volume token 50. If the inhibit copy flag 56 is “on” for volume ID 52 in either token, the logical volume is not to be copied and the flow proceeds to step 830. If the inhibit copy flag 56 is not “on” in either volume token 50, flow proceeds to step 825. In step 825, a copy operation for the logical volume identified by the volume ID 50 is placed in the queue for pending copy operations, and the flow continues to step 830. Now referring to step 830, the virtual tape controller 4 determines whether volume tokens 50 for all volume IDs 52 have been examined. If not all of the volume tokens 50 have been examined, control passes back to step 810. If the volume tokens 50 have all been examined, the logic flow is terminated in step 835.

The illustrated logic of FIGS. 4-8 show certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The described techniques for selective dual copy control of data storage and copying may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., magnetic storage medium such as hard disk drives, floppy disks, tape), optical storage (e.g., CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which implementations are made may further be accessible through a transmission media or from a file server over a network. In such cases, the article of manufacture in which the code is implemented may comprise a transmission media such as network transmission line, wireless transmission media, signals propagating through space, radio waves, infrared signals, etc. Of course, those skilled in the art will recognize that many modifications may be made to this configuration without departing from the scope of the implementations and that the article of manufacture may comprise any information bearing medium known in the art.

The foregoing description of various implementations of the invention has been presented for the purposes of illustration and description. It is not intended to be exhaustive, nor to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

The objects of the invention have been fully realized through the embodiments disclosed herein. Those skilled in the art will appreciate that the various aspects of the invention may be achieved through different embodiments without departing from the essential function of the invention. The particular embodiments are illustrative and not meant to limit the scope of the invention as set forth in the following claims.

1. A method of storing data to one of a first storage device and a second storage device in a data storage system where each storage device provides for redundant access to and storage of data on a logical data volume residing on both the first and the second storage device, the method comprising:
defining a storage construct which directs the performance of a storage function;
associating the storage construct with the logical data volume;
mounting the logical data volume residing on the first storage device; and
executing the storage function in accordance with the storage construct.

2. The method of claim 1 wherein the storage construct is defined by a command issued by a host connected to the data storage system.

3. The method of claim 1 wherein the storage construct is defined by a user of the data storage system through a user interface.

4. The method of claim 1 wherein the storage function comprises directing which one of the first and the second storage devices will execute I/O commands for a select logical data volume mount.

5. The method of claim 1 wherein the storage function comprises directing whether data stored to the logical data volume residing on the first storage device will be copied to the logical data volume residing on the second storage device.

6. The method of claim 1 wherein the first storage device and the second storage device are first and second virtual tape servers and mounting the logical data volume further comprises:
sending a mount command from a host associated with the data storage system to a virtual tape controller;
passing the mount command from the virtual tape controller to the first and second virtual tape servers;
processing the mount command in the first and second virtual tape servers, the processing including directing the association of the storage construct with the logical data volume;
passing the storage construct associated with the logical data volume back to the virtual tape controller; and
notifying the host of the completion of the mount operation.

7. The method of claim 6 wherein the storage construct associated with the logical data volume includes a management action directing the virtual tape controller to select one of the first and second virtual tape servers for the execution of host I/O commands for the duration of the logical storage volume mount.

8. The method of claim 6 wherein the storage construct associated with the logical data volume includes a management action directing the virtual tape controller to inhibit the copying of data stored to one of the first and second virtual tape servers to the other of the first and second virtual tape servers.

9. The method of claim 8 wherein a token database is associated with the logical data volume and the virtual tape controller places an inhibit copy flag in the token database.

10. The method of claim 9 wherein executing the storage function further comprises detecting whether an inhibit copy flag is set in the token database associated with the logical data volume.

11. A data storage system for storing data to a first storage device and a second storage device where each storage device provides for redundant access to and storage of data on a logical data volume residing on both the first and the second storage device, the data storage system comprising:
means for defining a storage construct which directs the performance of a storage function;
means for associating the storage construct with a logical data volume;
means for mounting the logical data volume residing on the first storage device; and
means for executing the storage function in accordance with the storage construct.

12. The data storage system of claim 11 further comprising means for defining the storage construct by a command issued by a host connected to the data storage system.

13. The data storage system of claim 11 further comprising means for defining the storage construct by a user of the data storage system through a user interface.

14. The data storage system of claim 11 wherein the storage function comprises selecting which one of the first and the second storage devices will execute I/O commands from the data storage system for a select logical data volume mount.

15. The data storage system of claim 11 wherein the storage function comprises directing whether data stored to the logical data volume residing on the first storage device will be copied to the logical data volume residing on the second storage device.

16. The data storage system of claim 11 wherein the first storage device and the second storage device comprise first and second virtual tape servers and the means for mounting the logical data volume further comprises:
means for sending a mount command from a host associated with the data storage system to a virtual tape controller;
means for passing the mount command from the virtual tape controller to the first and second virtual tape servers;
means for processing the mount command in the first and second virtual tape servers, the processing including directing the association of the storage construct with the logical data volume;
means for passing the storage construct associated with the logical data volume back to the virtual tape controller; and
means for notifying the host of the completion of the mount operation.

17. The data storage system of claim 16 wherein the storage construct associated with the logical data volume includes a management action directing the virtual tape controller to select one of the first and second virtual tape servers for the execution of host I/O commands for the duration of the logical storage volume mount.

18. The data storage system of claim 16 wherein the storage construct associated with the logical data volume includes a management action directing the virtual tape controller to inhibit the copying of data stored to one of the first and second virtual tape servers to the other of the first and second virtual tape servers.

19. The data storage system of claim 18 further comprising a token database associated with the logical data volume and the virtual tape controller comprises means for placing an inhibit copy flag in the token database.

20. The data storage system of claim 19 wherein the means for executing the storage function further comprises means for determining whether an inhibit copy flag is set in the token database associated with the logical data volume.

21. An article of manufacture for use in programming a data storage system to store data to one of a first storage device and a second storage device where each storage device provides for redundant access to and storage of data on a logical data volumes residing on both the first and the second storage device, the article of manufacture comprising instructions for:
defining a storage construct which directs the performance of a storage function;
associating the storage construct with a logical data volume;
mounting the logical data volume residing on the first storage device; and
executing the storage function in accordance with the storage construct.

22. The article of manufacture of claim 21 wherein the storage construct is defined by a command issued by a host connected to the data storage system.

23. The article of manufacture of claim 21 wherein the storage construct is defined by a user of the data storage system through a user interface.

24. The article of manufacture of claim 21 wherein the storage function comprises directing which one of the first and the second storage devices will execute I/O commands for a select logical data volume mount.

25. The article of manufacture of claim 21 wherein the storage function comprises directing whether data stored to the logical data volume residing on the first storage device will be copied to the logical data volume residing on the second storage device.

26. The article of manufacture of claim 21 wherein the first storage device and the second storage device are first and second virtual tape servers and mounting the logical data volume further comprises:
sending a mount command from a host associated with the data storage system to a virtual tape controller;
passing the mount command from the virtual tape controller to the first and second virtual tape servers;
processing the mount command in the first and second virtual tape servers, the processing including directing the association of the storage construct with the logical data volume;
passing the storage construct associated with the logical data volume back to the virtual tape controller; and
notifying the host of the completion of the mount operation.

27. The article of manufacture of claim 26 wherein the storage construct associated with the logical data volume includes a management action directing the virtual tape controller to select one of the first and second virtual tape servers for the execution of host I/O commands for the duration of the logical storage volume mount.

28. The article of manufacture of claim 26 wherein the storage construct associated with the logical data volume includes a management action directing the virtual tape controller to inhibit the copying of data stored to one of the first and second virtual tape servers to the other of the first and second virtual tape servers.

29. The article of manufacture of claim 28 wherein a token database is associated with the logical data volume and the virtual tape controller places an inhibit copy flag in the token database.

30. The article of manufacture of claim 29 wherein executing the storage function further comprises determining whether an inhibit copy flag is set in the token database associated with the logical data volume.
